(19) United States
(12) Patent Application Publication
(10) Pub. No.: US 2010/0155337 A1
(43) Pub. Date: Jun. 24, 2010

(54) PROCESS OF TREATING SEWAGE IN TERNARY COMBINATION FLOODING

(75) Inventors: Yanming GAO, Beijing (CN); Xingyu Liu, Beijing (CN); Shu-nan Gong, Beijing (CN)

Correspondence Address: SUGHRUE MION, PLLC, 2100 PENNSYLVANIA AVENUE, N.W., SUITE 800, WASHINGTON, DC, 20037, US

(73) Assignees: HIGH GRADE TECHNOLOGY CO., LTD., Beijing (CN); DAQING DAFENG OILFIELD TECHNOLOGY CO., LTD., Daqing City (CN)

(21) Appl. No.: 12/338,448

(22) Filed: Dec. 18, 2008

(51) Int. Cl. C02F 1/52; C02F 103/00

(52) U.S. Cl. 210/724

(57) ABSTRACT

The present invention discloses a process of treating ternary combination flooding sewage, in particular, comprising treating the ternary combination flooding sewage after oil-water separation process in the following steps in order: (1) adding 1000-6000 mg/l pH regulator into the sewage to regulate pH to 5.0-7.5; ) (2) adding 500-5000 mg/l coagulant into the sewage; (3) adding 100-1000 mg/l organic flocculant into the sewage; (4) standing the sewage to deposit and separating out floccus from the sewage; and (5) filtering the sewage by delivering it to a known filtration device; the steps(1), (2) and (3) are always carried out under stirring and the added agents are maintained to be sufficiently mixed with the sewage. The effect of the present invention is that the process can treat the ternary combination flooding sewage which is extremely difficult to treat so as to meet the standard, and that the process has been put into the industrialized pilot with a treating capacity of 5000 m³/day. The process can not only recover a large amount of crude oil, mainly but also treat a large amount of the contaminative sewage into qualified injected water.

### FIELD OF THE INVENTION

The present invention relates to a process of treating sewage in ternary combination flooding (ASP (Alkali/Surfactant/Polymer) flooding) used in an oil production plant in an oilfield.

### BACKGROUND OF THE INVENTION

Currently, Daqing Oilfield (China) has implemented ternary combination flooding in a large scale. The Shengli (China), Liaohe (China) oilfields and the like have also implemented ternary combination flooding in a small scale. They all achieved the effect of remarkably improving the yield of crude oil. However, as the oil production time prolonged, the amount of the withdrawn polymers, surfactants, alkalis and the like in the produced liquid is higher and higher, making the oil-water emulsification of produced liquid worse and worse and causing many difficult problems that urgently need to be solved, wherein a problem that urgently need to be solved and is most difficult to be solved is that of treating sewage in ternary combination flooding. A sewage in ternary combination flooding is the sewage obtained after oil-water separation by demulsification of produced liquids in ternary combination flooding. Because a large amount of polymers, alkalis, surfactants and the like are remained in the sewage of ternary combination flooding, the viscosity of the sewage, the emulsification degree of oil as well as the dispersion degree of suspended solids in the sewage increases, making oil-water separation and removal of suspended solids very difficult. In addition, due to the very large molecular weight of polymers in the sewage of ternary combination flooding, the polymer molecules are unable to pass through a 0.45 μm filtration membrane required under the SY/T 5392-95 standard The Recommended Criteria of Injection Water Quality in Detrital Reservoir and Analysis Methods Thereof, thereby making the content of suspended solids exceed the standard. The polymers must be removed in order to make the content of suspended solids meet oilfield requirements. However, it needs a large amount of agents to remove the polymers. Also, the pH of ternary combination flooding sewage is higher and may be between 9.3 and 9.8. Such a high pH value exceeds the range in which cation organic flocculants and some inorganic coagulants are used. The above problems all make the treatment of ternary combination flooding sewage difficult. Further, it is urgent for oil fields to treat the sewage, converting the sewage into usefulness while avoiding environmental pollution, recovering crude oil and using the treated sewage as re-injection water.

At present, the study on treating ternary combination flooding sewage just commences, and most of these studies are carried out in labs using simulated ternary combination flooding sewage, wherein the simulated water quality is largely different from in-situ sewage. The process of treating sewage studied with simulated sewage can not substantially be applied to treat in-situ sewage. After searching, the patents in treating ternary combination flooding sewage were not founded.

### SUMMARY OF THE INVENTION

The technical problem to be solved by the present invention is to provide a process of treating ternary combination flooding sewage, by which the ternary combination flooding sewage containing a large amount of polymers, alkalis, surfactants, oil, etc. can be treated into qualified re-injection water meeting each criteria requirement.

The technical solution of the present invention for solving its technical problem is:

after oil-water separation process, treating ternary combination flooding sewage in the following steps in order: (1) padding 1000-6000 mg/l pH regulator into the sewage to regulate pH to 5.0-7.5; (2)adding 500-5000 mg/l coagulant into the sewage; (3)adding 100-1000 mg/l organic flocculant into the sewage; (4)standing the sewage to deposit and separating out the floccus produced by the reaction after adding said coagulant and said organic flocculant in the previous steps from the sewage; and (5) filtering the sewage by delivering it to a known filtration device and finally obtaining qualified oil-field injection water; the steps(1), (2) and (3) are always carried out under stirring and the added pH regulator, coagulant and organic flocculant are maintained to be sufficiently mixed with the sewage.

Further, the above steps(1), (2) and (3) are carried out directly in the sewage delivery pipeline or in the reactors passed through by the sewage, respectively.

Further, the above step (4) is carried out in a depositor.

The above pH regulator and coagulant may also be premixed with each other, and then the mixed liquid, i.e. multifunctional coagulant after mixing, is added into the sewage with stirring, in the sewage delivery pipeline or the reactors passed through by the sewage.

Further, said pH regulator is one or a mixture of more than two of hydrochloric acid, sulfuric acid, nitric acid, phosphoric acid, industrial waste hydrochloric acid and industrial waste sulfuric acid.

Further, said coagulant is one or a mixture of more than two of poly aluminium chloride, poly aluminum sulfate, poly ferric aluminum sulfate, poly aluminum silicate chloride, poly aluminum silicate sulfate, aluminum chloride, potassium aluminium sulfate, sodium aluminate, aluminium ammonium sulfate, aluminium sulfate, magnesium chloride and calcium chloride.

Further, said organic flocculant is cationic, non-ionic, and anionic high molecule polymer of polyacrylamide or modified starch with molecular weight of more than 5,000,000.

The water quality after treatment is that oil content ≦10 mg/L; suspended solids content ≦10 mg/L; pH 6-9; polyacrylamide: not found; chroma: colorless and transparent.

The effect of the present invention is that the process can treat the ternary combination flooding sewage which is extremely difficult to treat so as to meet the standard, and that the process has been put into the industrialized pilot with a treating capacity of 5000 m³/day. The process can not only recover a large amount of crude oil, mainly but also treat a large amount of the contaminative sewage into qualified injected water.

### BRIEF DESCRIPTION OF THE DRAWINGS

FIG. 1 is a flow chart of a first embodiment of a process of treating ternary combination flooding sewage of the present invention.

FIG. 2 is a flow chart of a second embodiment of a process of treating ternary combination flooding sewage of the present invention.

### DETAILED DESCRIPTION OF THE INVENTION

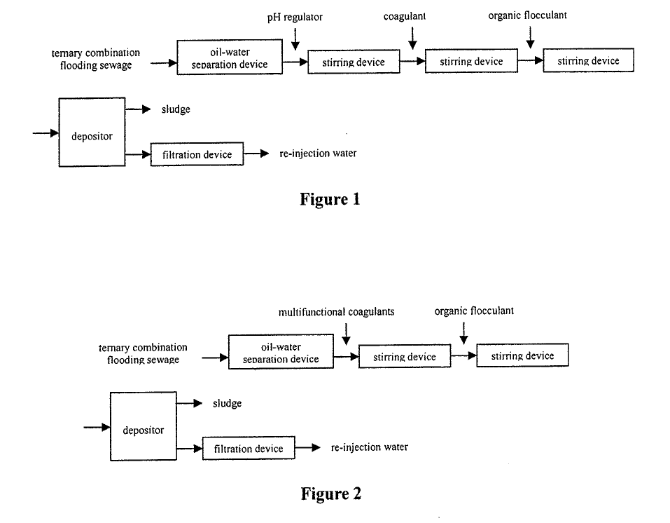

As shown in FIG. 1, the ternary combination flooding sewage is first subjected to oil-water separation to further recover crude oil in the sewage, then 1000-6000 mg/l pH regulator is added into the sewage with stirring through the sewage delivery pipeline or the reactors passed through by the sewage to make the regulator sufficiently mixed with the sewage and to regulate pH value of the sewage to 5.0-7.5; 500-5000 mg/l coagulant is added into the sewage with continued stirring through the sewage delivery pipeline or the reactors passed through by the sewage; after sufficiently mixed, with continuously stirring, 100-1000 mg/l organic flocculant is added through the sewage delivery pipeline or the reactors passed through by the sewage into the sewage; after sufficiently mixed, the sewage is sent into a depositor for static settlement; the floccus produced by reaction after adding coagulant and organic flocculant is separated from the sewage; then the sewage is sent into a known filtration device for filtration; and finally qualified oil-field injection water is obtained.

As shown in FIG. 2, the pH regulator and coagulant in the embodiment shown in FIG. 1 can also be premixed with each other, and then the mixed liquid is added with stirring into the sewage in the sewage delivery pipeline or the reactors passed through by the sewage.

The above used pH regulator may be selected from one or a mixture of more than two of hydrochloric acid, sulfuric acid, nitric acid, phosphoric acid, industrial waste hydrochloric acid and industrial waste sulfuric acid.

The above used coagulant is one or a mixture of more than two of poly aluminium chloride, poly aluminum sulfate, poly ferric aluminum sulfate, poly aluminum silicate chloride, poly aluminum silicate sulfate, aluminum chloride, potassium aluminium sulfate, sodium aluminate, aluminium ammonium sulfate, aluminium sulfate, magnesium chloride and calcium chloride.

The above used organic flocculants are cationic, non-ionic, and anionic high molecule polymers of polyacrylamides or modified starches with molecular weight of more than 5,000,000.

The sewage water quality before treatment is that oil content: 200-1000 mg/L; suspended solids content: 100-900 mg/L; polyacrylamide: 120-300 mg/L, surfactants: 10-100 mg/L, alkalis: 800-2000 mg/L and pH 9.4.

The water quality after treatment is that oil content ≦10 mg/L; suspended solids content ≦10 mg/L; pH 6-9; polyacrylamide: not found; chroma: colorless and transparent.

What is claimed is:

1. A process of treating ternary combination flooding sewage with the specific steps of: treating the ternary combination flooding sewage after oil-water separation process in the following steps in order: (1)adding 1000-6000 mg/l pH regulator into the sewage to regulate pH to 5.0-7.5; (2)adding 500-5000 mg/l coagulant into the sewage; (3)adding 100-1000 mg/l organic flocculant into the sewage; (4) standing the sewage to deposit and separating out floccus produced by the reaction after adding said coagulant and said organic flocculant in the previous steps from the sewage; and (5) filtering the sewage by delivering it to a known filtration device and finally obtaining qualified oil-field injection water; the steps(1), (2) and (3) are always carried out under stirring and the added pH regulator, coagulant and organic flocculant are maintained to be sufficiently mixed with the sewage.

2. The process of treating ternary combination flooding sewage of claim 1, characterized in that the steps(1), (2) and (3) are carried out directly in the sewage delivery pipeline or in the reactors passed through by the sewage, respectively.

3. The process of treating ternary combination flooding sewage of claim 1, characterized in that the step (4) is carried out in a depositor.

4. The process of treating ternary combination flooding sewage of claim 1, characterized in that the pH regulator in the step (1) and the coagulant in the step (2) are premixed with each other, then the mixed liquid is added into the sewage, and the subsequent treatment steps continued.

5. The process of treating ternary combination flooding sewage of claim 1, characterized in that said pH regulator is one or a mixture of more than two of hydrochloric acid, sulfuric acid, nitric acid, phosphoric acid, industrial waste hydrochloric acid and industrial waste sulfuric acid.

6. The process of treating ternary combination flooding sewage of claim 1, characterized in that said coagulant is one or a mixture of more than two of poly aluminium chloride, poly aluminum sulfate, poly ferric aluminum sulfate, poly aluminum silicate chloride, poly aluminum silicate sulfate, aluminum chloride, potassium aluminium sulfate, sodium aluminate, aluminium ammonium sulfate, aluminium sulfate, magnesium chloride and calcium chloride.

7. The process of treating ternary combination flooding sewage of claim 1, characterized in that said organic flocculant is cationic, non-ionic, and anionic high molecule polymer of polyacrylamide or modified starch with molecular weight of more than 5,000,000.
